(19) United States
(12) Patent Application Publication
(10) Pub. No.: US 2008/0126260 A1
(43) Pub. Date: May 29, 2008

(54) Point Of Sale Transaction Device With Magnetic Stripe Emulator And Biometric Authentication

(76) Inventors: Mark A. Cox, West Chester, PA (US); John K. Bona, York, PA (US)

Correspondence Address: FOX ROTHSCHILD, LLP, 625 LIBERTY AVENUE, PITTSBURGH, PA, 15222-3155, US

(21) Appl. No.: 11/943,575

(22) Filed: Nov. 20, 2007

Related U.S. Application Data
(63) Continuation-in-part of application No. 11/456,906, filed on Jul. 12, 2006.
(60) Provisional application No. 60/866,909, filed on Nov. 22, 2006.
(60) Provisional application No. 60/866,922, filed on Nov. 22, 2006.
(60) Provisional application No. 60/942,729, filed on Jun. 8, 2007.

(51) Int. Cl. G06K 19/06

(52) U.S. Cl. 705/67

(57) ABSTRACT

A handheld unit which is capable of emulating a plurality of smartcards or magnetic stripe cards. The unit has the capability of storing a plurality of data sets representing a plurality of accounts. The unit is equipped with an RF interface that can emulate a smartcard interface that is capable of communicating with smartcard readers at POS or ATM terminals, or anywhere else a smartcard may be utilized. The unit is also equipped with a programmable magnetic strip such that it can be used anywhere a magnetic stripe card can be swiped or inserted. The unit is equipped with a biometric sensor to positively verify an authenticated user.

### RELATED APPLICATIONS

This application is a continuation-in-part of co-pending U.S. application Ser. No. 11/456,906, filed Jul. 12, 2006, and claims the benefit of U.S. provisional applications 60/866,909, filed Nov. 22, 2006, entitled “Biometrically Secured Point Of Sale Transaction Device, 60,866,922, filed Nov. 22, 2006, entitled “Affinity Card With Biometric Security”, and 60/942,729, filed Jun. 8, 2007, entitled “Smartcard and Magnetic Stripe Emulator Having Biometric Authentication With Enhanced Features.

### BACKGROUND OF THE INVENTION

Plastic credit card issuers lose billions of dollars worldwide each year to credit card fraud. These losses are often offset to some degree by passing off to consumers and merchants in the form of higher transaction fees and interest rates. However, the losses to the credit card issuers are still substantial.

Credit card information can be obtained for fraudulent use in a number of different ways. Recent cases have shown employees or hackers obtaining unauthorized access to merchant or card processor databases, compromising millions of credit and debit card accounts. Frequently, the credit cards themselves are lost or stolen, making it possible for the thief to make unauthorized charges on the account until the account can be cancelled. Account information can also be illegally obtained through identity theft, wherein a thief poses as an individual, or by what is know as “skimming” or “cloning”, which are high-tech methods used by thieves to capture personal information or account information from the magnetic stripe on a credit card.

Because account information is static, once it has been compromised, it can be used to make fraudulent transactions at multiple merchant sites, or by online transactions and other “card not present” transactions, such as mail order or phone order. It would therefore be desirable to have a way of making the information required to complete a credit card transaction dynamic, that is, changing after every transaction, thereby greatly limiting the opportunities for fraudulent transactions to occur. The “chip and pin” initiative in the United Kingdom is a step in this direction. This program utilizes a smartcard type of credit card and requires the user to enter a PIN number when making a transaction in lieu of a signature. The PIN number is matched with the number stored on the chip inside the smartcard. Note that this arrangement, while a step in the right direction, does not solve fraud in “card not present” transactions.

Radio frequency identification devices (RFID) are well known in the art. A typical RFID device includes an antenna and a chip that is activated by RF energy emitted by a reading device. The antenna on the reading device induces a signal into an RFID chip which is in close proximity to the reading device, causing the RFID device it to transmit a small amount of data back to the reading device. An RFID tag can be thought of as similar in usefulness to a bar code.

RFID has found its way into many applications, including inventory control and tracking, as substitutes for traditional magnetic strip cards for electronic payments at point of sale (POS) locations, devices for automatically paying tolls on highways, passports and personal identification cards. RFID devices have even been used as embedded devices within living beings such as domesticated pets and children.

A “smartcard” is a card that is embedded with either a microprocessor and a memory chip or a memory chip with non-programmable logic. The microprocessor can add, delete, and otherwise manipulate information on the card, while a memory-chip card can only undertake a pre-defined operation. Although smartcards utilize radio frequency (RF) to transmit and receive data, they are unlike traditional RFID tags or magnetic strip cards in that all necessary functions and information necessary for the completion of a transaction can be carried on the card. Therefore, they do not require access to remote databases at the time of the transaction. Smartcards are governed by many standards, in particular, ISO/IEC standards 7816 and 14443. The previously mentioned “chip and pin” program in the UK utilizes this type of card.

The smartcard is quickly replacing the traditional method of ‘swiping’ credit cards with data contained on magnetic stripes. At a point-of-sale (POS), the smart card is activated by a contactless reader attached to an external device required for the application, for example, an RFID reader attached to a cash register. The reader's RF antenna induces a signal into the card's RF antenna, thereby activating the smart card. The application can then communicate with the smart card via the reader unit to transmit the cardholder's account data back to the point of sale application, utilizing a command set specified by the ISO 7816 standard.

While smart cards allow transactions to be performed at a faster rate than traditional magnetic stripe cards, they only offer a small improvement in security to guard against account data theft than the conventional magnetic stripe credit cards they are replacing. A closer examination of this technology reveals several inadequacies that will allow fraudulent and illegal trends to emerge. First, owners making a purchase no longer enter PIN numbers or sign a printed copy of the credit card transaction. Therefore, if a smartcard is lost or stolen, it can be used to make unauthorized purchases. Also, there are new security threats that are technically possible against contactless smart cards. A lost or stolen smart card also contains all the required information thereon, including the account number, CCV and any other information necessary to complete a transaction, that can be easily read and copied. Differential Power Analysis (DPA) and Simple Power Analysis (SPA) may be used to steal the security keys for communication encryption and decryption. In addition, smartcards are subject to certain types of attacks, known as “relay” attacks, in which a smartcard not in close proximity to a POS-based reader can be used by “relaying” its information through another reader and smartcard pair.

These deficiencies represent a dramatic financial threat to both the issuing institutions and the card owners. While credit card companies and insurance companies that underwrite fraud coverage usually absorb the losses associated with fraudulent activity, the long-term implications for victims and their credit ratings are very serious. Additionally, it is intuitive that any perceived security risk associated with smartcard technology would represent an obstacle to widespread market acceptance. Therefore, it would be advantageous to provide a means of securing the data stored within smartcards from being covertly and illegally harvested.

### SUMMARY OF THE INVENTION

The present invention is a cost effective device capable of storing the information from multiple smartcards and data from multiple conventional magnetic stripe cards for use either through a magnetic stripe emulator or as a ‘virtual’ contactless smartcard, and preventing both unauthorized use of the device and outright theft of the information on the device via a biometric recognition technology, such as, for example, fingerprint verification or voice recognition. In this capacity, the theft of account data via relay attack, as well as crimes associated with lost or stolen smartcards, will be virtually eliminated.

In the preferred embodiment, the present invention is comprised of two components, a software application running on a personal computer and a handheld portable data storage and transmission device. Optionally, an associated base unit may also be provided.

The handheld device, in the preferred embodiment, is the size of a credit card, and conforms to the ISO 7813 standard of 0.76 mm in thickness. It contains a display and a keypad, as well as several navigation buttons to navigate through the accounts and applications and to make appropriate selections. Optionally, a portion of the device also contains a programmable magnetic stripe. The device is equipped with a main processor capable of executing simple applications, as well as a smartcard chip set and related antenna.

The device may also incorporate a near field communications (NFC) capability which is compatible with the ISO 14443 standard. NFC is a peer-to-peer connection that allows the transfer of larger amounts of data than a simple query and reply smartcard. The NFC capability can therefore emulate a smartcard. The NFC capability may also be used for downloading various data to device, such as electronic receipts, coupons, advertising content, electronic tickets, etc. Additionally, the device is capable of communicating with NFC-enabled POS terminals, for purposes of transmitting account information, coupon information, and other types of information to the POS terminal, and can also receive information, such as an electronic receipts, from the POS terminal. Additionally, the device will be able to communicate with other NFC-enabled devices, such as kiosks, where discount coupons may be available, and ticketing agents, where event tickets may be purchased and stored electronically until their use.

Most importantly, the device incorporates a biometric sensor for performing fingerprint or other biometric identification to positively identify the user as the owner of the device. This provides the means to ensure that only the authorized card owner is actually performing the transaction. In the preferred embodiment, fingerprint verification is used to biometrically identify the authorized user, however, other means of identifying the users, both biometric and non-biometric may also be used. Authentication is required for each transaction, and the identity of the authorized user must be verified before the device's programmable magnetic stripe, smartcard circuitry or NFC circuitry is activated, and its signal transmitted to an RFID reader or NFC-enabled POS terminal. Authentication may not be required for all functions of device. For example, it may not be desirable to require authentication for the downloading of coupons.

Preferably, one embodiment of the device will have standard smartcard contacts. The optional base unit will contain mating connectors which will allow data transfer between the device and an application program running on a standard personal computer, and which will also allow charging of the device's rechargeable batteries through the smartcard contacts. In addition, the base unit may optionally contain an NFC or smartcard reader, such that the base can act as a POS terminal for on-line purchases.

The handheld device will communicate with an application running on a personal computer, and will preferably be connected to the personal computer via a base unit, or, alternatively, directly via a wireless connection, such as Bluetooth. The personal computer application allows the downloading of account information from multiple credit or other type cards into the device, and can be synchronized with the handheld device when they are connected, such that the data on the personal computer mirrors the data on the handheld device. The personal computer application will also provide other functionality which will be discussed in detail herein. The device contains ample memory to store account information from multiple conventional magnetic stripe cards and smartcards.

The handheld device can also emulate a magnetic stripe card by utilizing a programmable magnetic stripe which can be re-programmed on the fly and which can be erased after a pre-determined period of time or number of uses for security purposes. Account information from cards having a magnetic stripe may also be transmitted via an RF signal, in the event that an RF reader is available at the POS terminal. In this fashion, conventional magnetic stripe card owners will be able to perform transactions at venues utilizing the more desirable contactless, RF technology.

The handheld device must be initialized prior to the downloading of account information. The initialization process begins with a user enrollment step, in which the user is prompted to place one or more fingertips on the biometric sensor. The fingerprints are then scanned, converted into digital templates, and stored in the memory of the handheld device. The fingerprint templates can then be used for the authentication and activation process prior to the programming of the magnetic stripe or any RF signal transmission. Optionally, multiple users may be enrolled to use the various accounts stored on the card.

Use of an account stored on the device depends upon the user biometrically establishing his or her identity and then selecting a particular account, which becomes the “active” account. To authenticate, the user places a finger on the biometric sensor and the fingerprint is scanned and matched against one of the fingerprint templates stored on the device. Optionally, multiple fingerprints from different fingers may be required to unlock the device. In this capacity, any unauthorized use of the card is prohibited, thereby adding a new level of security to transactions with both conventional and smartcards.

One shortcoming of fingerprint recognition is that a small percentage of the population lacks a ‘usable’ fingerprint pattern for this purpose. In such cases, the users may optionally have the ability to enter a personal identification number (PIN) as an alternate method of authentication. During initialization, the user will be prompted to select either fingerprint or PIN for authentication. Once the PIN is entered the device will store the selected application data set in memory.

For security purposes and to prevent certain types of security attacks on the device, The RF antenna in the device is disabled after a single use. Without an enabled antenna, an interrogating RF signal will not be received and the device will not be able to transmit a response signal. When a subsequent transaction is desired, and the authentication process is completed, the antenna is re-enabled for a time sufficient to complete the transaction, then automatically disabled. Alternatively, the device could be enabled for a single transmission of the account data. For transactions involving a magnetic stripe, the programmable magnetic stripe on the device is erased after a predetermined period of time to prevent re-use. The device may also contain circuitry to record and time-stamp all attempts at retrieving data, including both authenticated attempts and attempts to use the device without authentication.

The device may optionally be equipped with a camera of the type frequently found on cellular telephones. The camera may be used to capture information from coupons by taking a photo of the coupon's barcode. In such cases, the device is also equipped with barcode reading software which is able to read the bar code from the captured photograph and display the information to the user in plain-text.

The inventors envision other types of biometric methods used with the device for authentication, including but not limited to, voice recognition, skin resistance and skin capacitance, and any other type of biometric verification now known or later invented.

### BRIEF DESCRIPTION OF THE DRAWINGS

FIGS. 1a through 1d show front, back, side and bottom views of the device of a first embodiment of the device.

FIG. 2 shows the optional base unit of the invention to be used with the first embodiment.

FIG. 3 shows the front face of a preferred embodiment of the device having a credit card or smartcard form factor.

FIG. 4 shows the back face of the preferred embodiment of the device, showing the magnetic stripe emulator.

FIG. 5 is an internal view of the preferred embodiment of the device, showing components in schematic form.

FIG. 6 is a system diagram of the preferred embodiment of the device, showing the interconnection of the various components.

FIG. 7 is a schematic of an exemplary configuration of the hardware architecture of the preferred embodiment of the device.

FIG. 8 is an exemplary configuration of the high level software architecture of the device.

FIG. 9 is a flow chart showing the enrollment of a user on the device.

FIG. 10 is a flow chart showing the biometric authentication of a user.

FIG. 11 is a flow chart showing the device provisioning process wherein electronic account records are downloaded from account issuers.

FIG. 12a is a first embodiment of a flow chart showing the selection and activation process of an account.

FIG. 12b is a flow chart showing an alternative embodiment of the process by which accounts are selected and activated.

FIG. 13 is a functional diagram of the menu structure of the software application which may optionally be present on the handheld device.

FIG. 14 is a functional diagram of the supporting application running on the personal computer.

FIG. 15 is a first example of a device and reader application utilizing a magnetic swipe or a contactless smartcard model as a communications medium.

FIG. 16 is a second example of a device and reader application utilizing NFC as the communications medium.

FIG. 17 is a flow chart of a transaction using the device of the present invention wherein a dynamic security code is generated on a per-transaction basis.

FIG. 18 is a diagram showing the general structure of a data record for an account downloaded into the device.

### DETAILED DESCRIPTION OF THE INVENTION

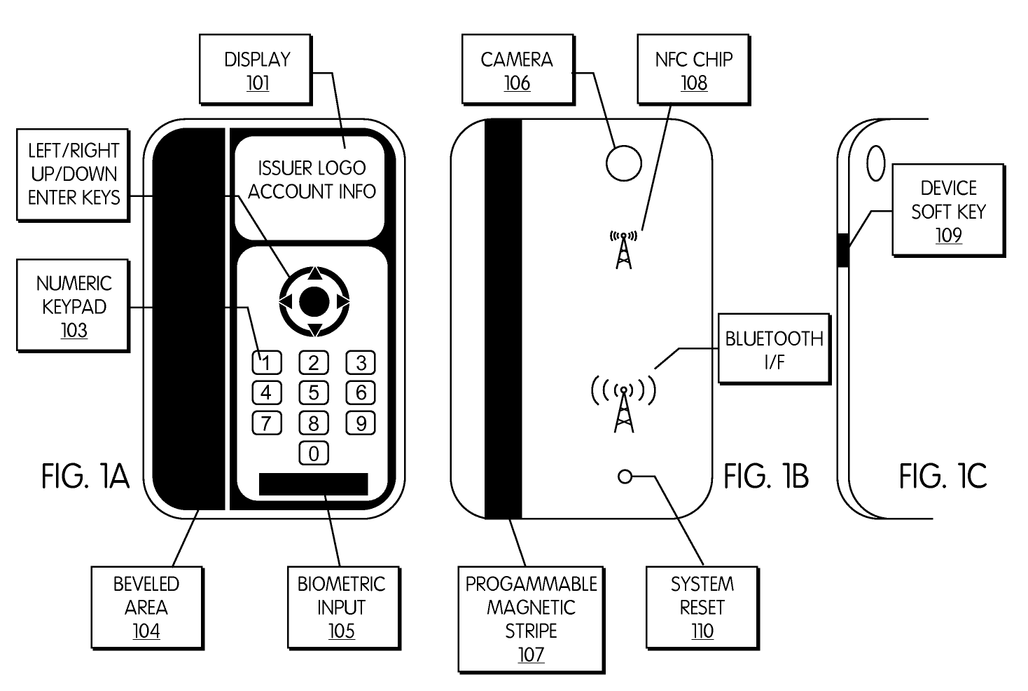

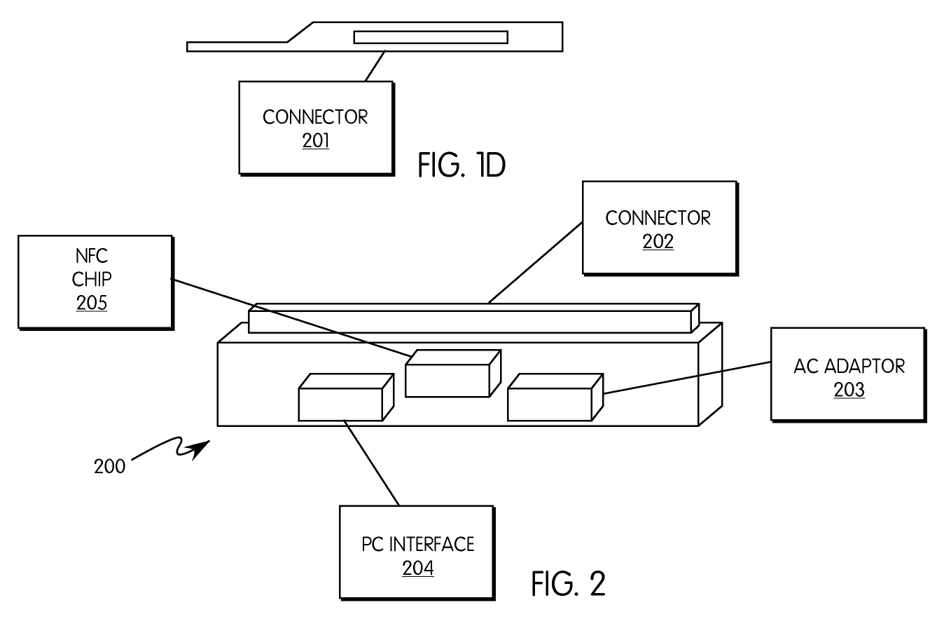

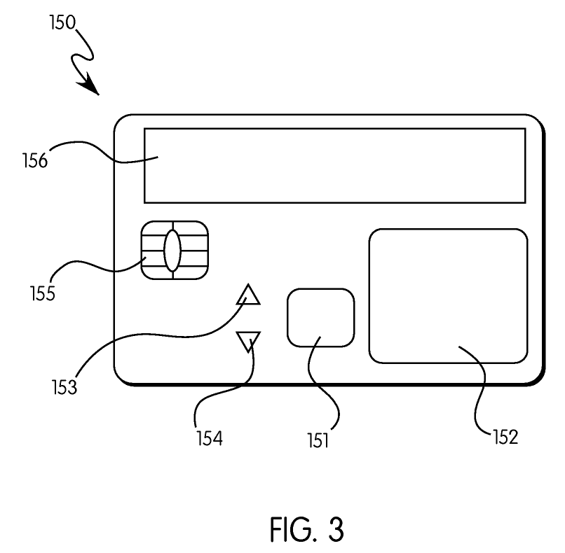

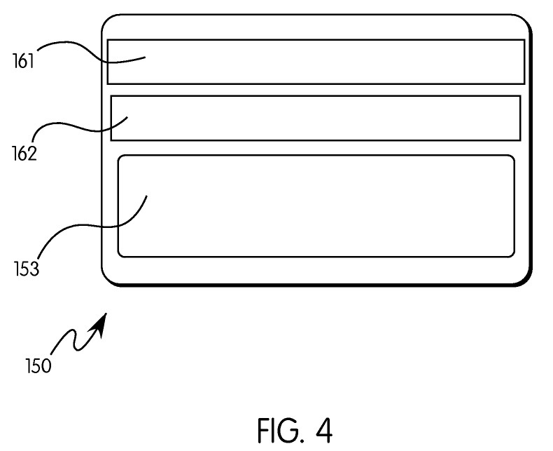

The device of the present invention is contemplated to be produced in one of two embodiments. In one embodiment, shown in FIGS. 1a through 1d, the device has two portions having different thicknesses. One portion of the device is the thickness of a typical credit card, while a second portion is thicker, allowing more room for physical components. In a second, and preferred embodiment, shown in FIGS. 3 and 4, the entire device is the thickness of a typical credit card, and is able to be used in all places that a credit card is able to be used, including those, such at ATMs and gas pumps, that require full insertion of the card.

FIG. 1a-1c shows front, back and side views respectively of the exterior of the first embodiment of device 100, which contains two portions, thinner portion 100a and thicker portion 100b. Thicker portion 100b preferably is about 10 mm or less in thickness and may be composed of any material commonly used for housing electronic devices, but is preferably composed of a material that will not interfere with the transmission or reception of RF signals. The front of device 100 contains display 101, which may be an LCD display, as well as menu selection keys 102 and numeric keypad 103. Menu selection keys 102 facilitate navigation through a series of menus displayed on display 101. Menu selection keys 102 consist of directional keys, which may be used move a cursor up, down, left or right, while a central ENTER key may be used to select menu items. The directional keys and ENTER key may be of any configuration.

Thinner portion 100a of device 100 contains a programmable magnetic stripe 107 of the rear side thereof and is preferably approximately 0.76 mm in thickness, in accordance with ISO standard 7813. The thickness of portion 100a of device 100 is such that it can be passed through a typical magnetic stripe card reader. Between sections 100a and 100b is a beveled area 104 which makes the transition from the thin portion of device 100 to the thick portion. The thinner portion 100a of device 100 and magnetic stripe 107 are optional. It is envisioned that future versions of the device will be made without the programmable magnetic stripe 107, as magnetic stripe credit cards and readers are phased out in favor of contactless transaction devices. In such cases, thinner portion 100a of device 100 may be absent.

Also located on the front of device 100 is biometric input sensor 105 which, in the preferred embodiment, consists of a fingerprint scanner. In other embodiments of the invention, other biometric authentication devices may also be used, such as voice recognition, skin pH analysis, or any other means of identifying the user, now known or later invented. In addition, the biometric authentication may be replaced an alphanumeric password or PIN that the user may enter into device 100 using numeric keypad 103.

The rear of the device contains programmable magnetic stripe 107 situated on the thin portion 100a of device 100. Also located on the back of the device is optional camera 106, which is used primarily in the preferred embodiment for taking photographs of barcodes which can be read through barcode recognition software, however, any images may be captured and stored on the device for display or transmission. In addition, NFC chip 108 and Bluetooth chip 109 are shown on the rear of device 100, however, these chips are actually internal to the device. Also located on the back of device 100 may be system reset button 110.

The side view of device 100 in FIG. 1c shows device soft key 109, which is used by the user to interact with the software application programmed into the device.

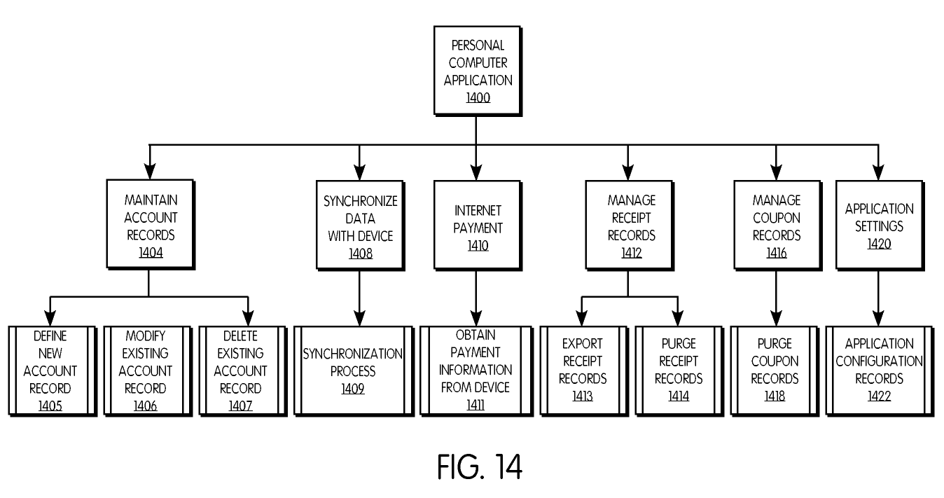

FIG. 1d shows the bottom of device 100 showing thin area 100a having the magnetic stripe 107 disposed thereon, thicker area 100b and the beveled transition 104 therebetween. Also present on the bottom of device 100 is connector 201 which may be used to transfer data to and from PC application 1002, shown in FIG. 15, via a direct cable connection or via base unit 200, shown in FIG. 3.

Optional base unit 200, contains connector 202 which mates with connector 201 on the bottom of device 100 to provide the aforementioned functions. Base unit 205 may also contain an NFC chip 205, or other wireless means of communication, which will allow base unit 200 to act as an contactless point-of-sale (POS) terminal for purchases made on-line. Also present on base 200 is PC interface 204, which allows device 100 to communicate with PC application 1002. The means for allowing device 100 to communicate with PC application 1002 may also be any one of a number of wireless transfer protocols well known in the art, such as Bluetooth or may be a wired connection, such as a serial line or a USB connection.

Connector 201 may be used to charge rechargeable battery 405 within device 100, either via a connection to base unit 200 or via a direct cable connection to a PC. AC adapter 203 for base unit 200 may provide power for re-charging battery 405. Alternatively, battery 405 may be inductively charged via voltages induced on the RF antenna of the device through interaction with an electromagnetic field.

FIGS. 3 through 5 show the physical configuration of the preferred embodiment of the invention. In this embodiment, device 150 has the dimensions and thickness of a typical credit card. The face of device 150 is shown in FIG. 3 and includes display area 152 for displaying the active account information, which can be selected using buttons 153 and 154. Although two buttons are shown in the exemplar preferred embodiment, it is obvious that any number of buttons could be used for the user interface of the device.

Note that the display area 152 is not meant to be limited to the size and shape shown, but may be of any convenient size and shape. Preferably, display 152 is an LCD display, but may be of any type well known in the art, including specifically electrophoretic displays capable of retaining an image after device 150 is powered down. The device may be capable of displaying color pictures as well as video, in anticipation of uses of device 150 for other than financial transactions. In the preferred embodiment, display 152 will be used primarily for the display of the currently active account and for prompts for the user. The account information displayed may include a graphic, preferably representing a logo or trademark of the account issuer, as well as any other information necessary to complete the transaction, such as CCV codes or dynamically generated PIN numbers.

The account information which is displayed on display 152 will be the “active” account. The information required for transactions using the active account will be programmed into programmable magnetic stripe 161, shown in FIG. 4, or transmitted via an RF capability, after the user has authenticated himself utilizing biometric sensor 151. Preferably, biometric sensor 151 is a fingerprint scanning device capable of scanning the fingerprints of one or more fingers of a typical user and matching them against stored templates, however, any other biometric sensor, now known or later develop, may be used. Additionally, a PIN number may be utilized.

Area 156 on the front of device 150 is a printable area which allows logos or other information to be printed on the card. Preferably, the card will not be embossed and, for added security, will not show account information on the face of the card unless displayed on display 152.

Contacts 155 are those typical to a smartcard and conform to the ISO standards for smartcards. These contacts will allow the transfer of data between the device and an application running on a PC via base unit 700, and will also allowing charging of the rechargeable battery of the card through the smartcard contacts.

FIG. 4 shows the configuration of the rear of device 150. Area 160 is an optional area which would allow printed information to appear on the card. Area 162 is an optional signature area conforming to the standard signature area of a typical credit card. Programmable magnetic stripe 161 is shown at the top of the card in the typical place of the magnetic stripe of a conventional credit card.

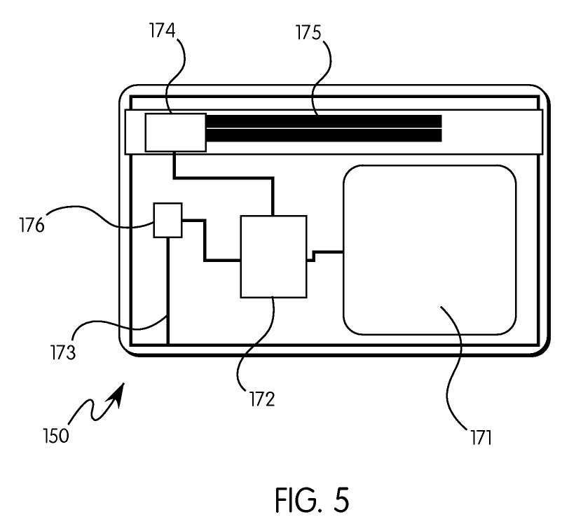

FIG. 5 shows the internal components of the card in schematic form. Battery 171 is a rechargeable battery, preferably composed of a thin film lithium polymer which can recharge via smartcard contacts 155, shown in FIG. 3, when device 150 is placed in the base unit 700. It is also contemplated that the battery may be recharged inductively though current induced in RF antenna 173 by contact with an electromagnetic field or an RF wave.

Component 172 is the system board of the device, which contains a central processing unit and related memory, as well as other components which will be discussed in more detail later. Component 173 is an RF antenna enabling the device to handle contactless transactions at POS terminals The device will allow the transmission of account information when interrogated by a typical smartcard reader via antenna 173. Typical smartcard readers provide power to a smartcard and communications through induction through the antenna. However, this device, being self-powered, may not require that feature, although it is contemplated that the device may be able to achieve an “emergency charge” suitable for at least one transaction using inductive transfer of power through the RF antenna. Preferably, however, this device will use the antenna only to communicate with the contactless smartcard reader.

Component 176 is the smartcard circuitry which supports the smartcard contacts and the contactless smartcard interface and communications, and would include memory holding the active account information which must be transmitted to a POS device to conclude a transaction.

Component 174 is the control for the magnetic stripe emulation, which is a custom chipset which will control the storage and transmission of track 1 and track 2 data necessary to conclude a transaction at a POS terminal. Component 175 is the transmitter for track 1 and track 2 of the programmable magnetic stripe. It is also contemplated that a POS device may write data onto any one of the tracks of the magnetic stripe, and that the magnetic stripe emulation control 174 would be able to read such information and store it in memory 403 of device 150 in an area associated with the currently active account information.

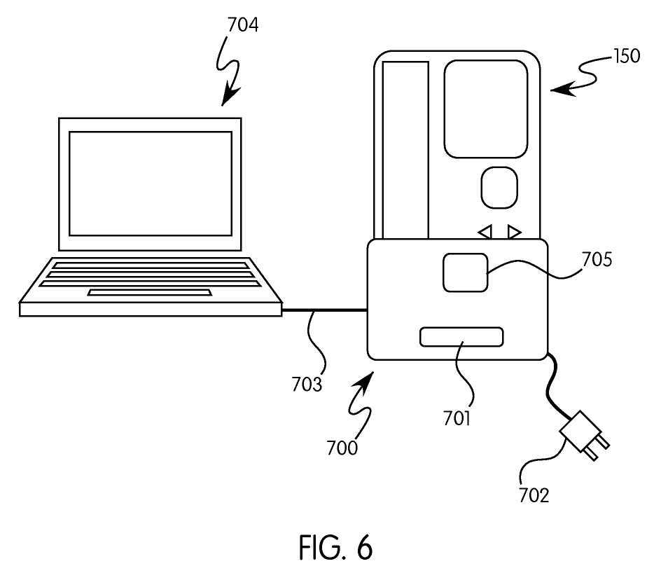

FIG. 6 shows a system diagram for the preferred embodiment of the current invention. Base unit 700 provides a connection point between device 150 and a typical personal computer (PC) 704. The connection between base unit 700 and PC 704 may be any conventional means well known in the art such as a cable to connection typically a serial line or a USB connection or a wireless connection such as Bluetooth. However, any well known communications protocol now known or later conceived can be used. Base unit 700 contains a removable battery 701 which may be used to charge the internal battery 171 of device 150. Removable battery 701 may be any type of consumer grade battery, such as a 9 v battery or a plurality of “AA” or “AAA” batteries. Optionally, AC adapter 702 may be used for the same purpose. Insertion of device 150 in base unit 700 allows both the transfer of data between PC 704 and device 150 and in addition, charging of the internal battery 171 of device 150. Both data transfer and charging of the battery occur through smartcard contacts 155. When device 150 is placed in base unit 700, contact 705 within base unit 700 make electrical contact with the smartcard contacts 155 on the front face of the device 150. This allows the transfer of data between the base unit 150 and the PC application 1002 running on PC 704 which will be discussed in more detail later. In addition, the rechargeable battery 171 may be recharged through smartcard contacts 155.

It is also contemplated that rechargeable battery 171 could be recharged with a portable charger in the form of a shaped clip or soft envelope which fits over device 150. This charger (not shown) would be powered by a single battery, possibly a wafer battery. Such a charger could be built into a wallet or purse and provide a convenient place to store device 150 between uses, while keeping battery 171 in device 150 charged.

In another embodiment, device 150 could be coupled with a cellular telephone for recharging purposes, with the cellular telephone having a slot to accommodate device 150. Inserting device 150 into the slot will cause smartcard contacts 155 to come into electrical contact with charge points on the cellular phone for purposes of charging rechargeable battery 171. In is also contemplated that a data transfer capability exist between device 150 and the cellular phone for purposes of data transfer over the cellular telephone network. For example, data regarding transactions could be encrypted and sent over the cellular telephone network to credit card processors of to a central cite for other processing.

It is also contemplated that device 150 could at some point be integrated into a cellular telephone. In such cases, transactions would be completed via the RF or NFC capability with similarly-enabled POS terminals. Because of thickness concerns, such implementations may not have programmable magnetic stripe 161, or would have a retractable programmable magnetic stripe 161 which would be housed in a slot on the phone when not in use and which would be extended from the housing of the phone when in use.

In yet another embodiment, a solar assist option could be used to charge battery 171 in which a photovoltaic cell (not shown) would draw charge from ambient light sufficient to keep battery 171 charged or to slow the drain of battery 171. Additionally, light could be drawn from the backlighting of the LCD display 152 of device 150 to provide current to slow the drain of battery 171.

In the preferred embodiment shown in FIGS. 3-5, device 150 is preferably flexible in construction as would be a prior art credit card. Device 150 may also be waterproof.

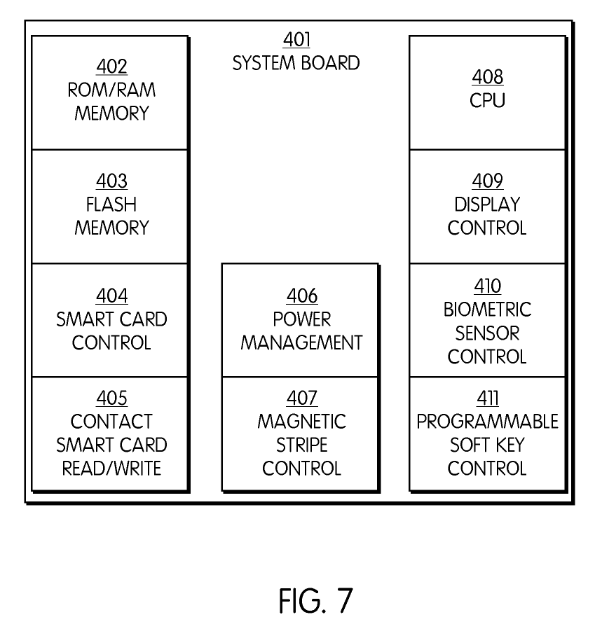

FIG. 7 is a schematic architectural diagram of the system board 401 of device 150. System board 401 contains most of the components for control and use of the device. CPU 408 is the main processor for device 150 and provides for the overall control of device 150, and will run the main operating system software and applications. Memory 402 is memory which is necessary for the operation of the device and may contain control software and application programs. Flash memory 403 is used for the secure, long term storage of application data and electronic account records.

Smartcard control 404 contains software and hardware which controls the interaction of the CPU 408 with smartcard circuitry 176. Contact smartcard read/write 405 controls the input and output of data and power delivery through the standard smartcard contacts 155, located on the front face of device 150.

Power management component 406 controls the status of rechargeable battery 171 and the delivery and conditioning of power for recharging battery 171 when the device is connected to base 700.

Magnetic stripe control 407 is the interface with magnetic stripe control circuitry 174 and provides the account data which is to be programmed into programmable magnetic stripe 161. In addition, Magnetic stripe control 407 may determine when programmable magnetic stripe 161 should be erased or otherwise disabled.

Display control 409 is responsible for images and information being displayed on display 152 located on the front face of the card.

Biometric sensor control 410 collects input from biometric sensor 151 located on the front face of device 150 and passes it to the biometric enrollment and authentication software, which is part of the main system software. Alternatively, this function could be provided by biometric sensor control component 410.

Programmable soft key control 411 controls the input of scroll keys 153 and 154, as well as any other inputs which may be present on the card.

In addition to the components shown in the preferred embodiment, additional circuitry may be included on main system board 401 of the device or may be included as separate components within the device. These include but are not limited to an onboard camera, a Bluetooth interface and a near field communications capability. Note that the architecture shown in FIG. 7 is only provided as an exemplar, and that an engineer of skill in the art could provide many alternative designs which are functional and which would still be considered to be within the scope of this invention.

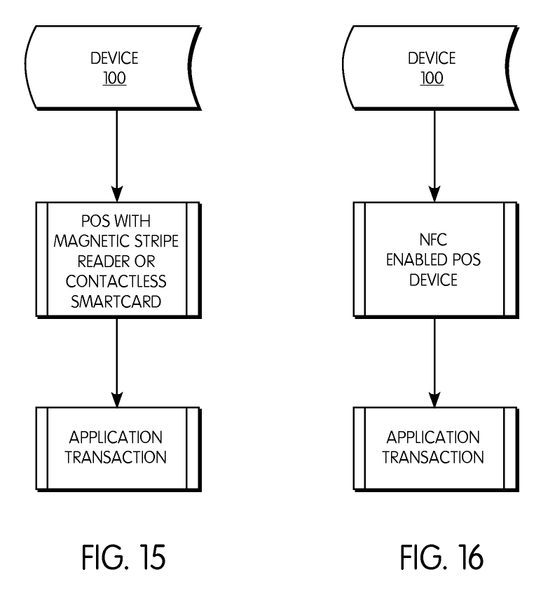

FIG. 16 shows the software architecture of the device, including all software components. Device application 501 is the primary software application controlling device 150 and running on CPU 408. This provides a basic input output processing and provides the main functionality and control of device 150. Device application 501 will run on device operating system 503, which may be any operating system now know or later developed that may be used in portable devices, such as, for example, LINUX or the Java Card Open Platform (JCOP), however, any appropriate operating system can be used. Device operating system 503 will perform all of the basic tasks to control the internal components of the device and provides a software platform on which device application 501 can be run.

Biometric enrollment and authentication component 502 is the software component which allows both the initial capture of the biometric templates and the storage of the templates necessary for later use in biometric authentication. In addition, biometric enrollment and authentication component 502 is responsible for reading scans for the biometric sensor 151 and comparing them to stored templates to verify the identity of the user. If the authentication process is not successful, the device is not activated.

Software component 504 is the smartcard operating system which manages the smartcard command and reply systems Smartcard operating system 504 may be part of device operating system 503.

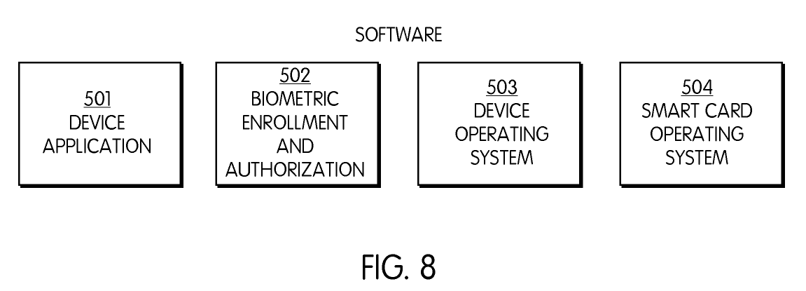

As with the hardware components, the architecture provided in FIG. 8 is only exemplary in nature, and may be of any alternative design and still be within the scope of the invention.

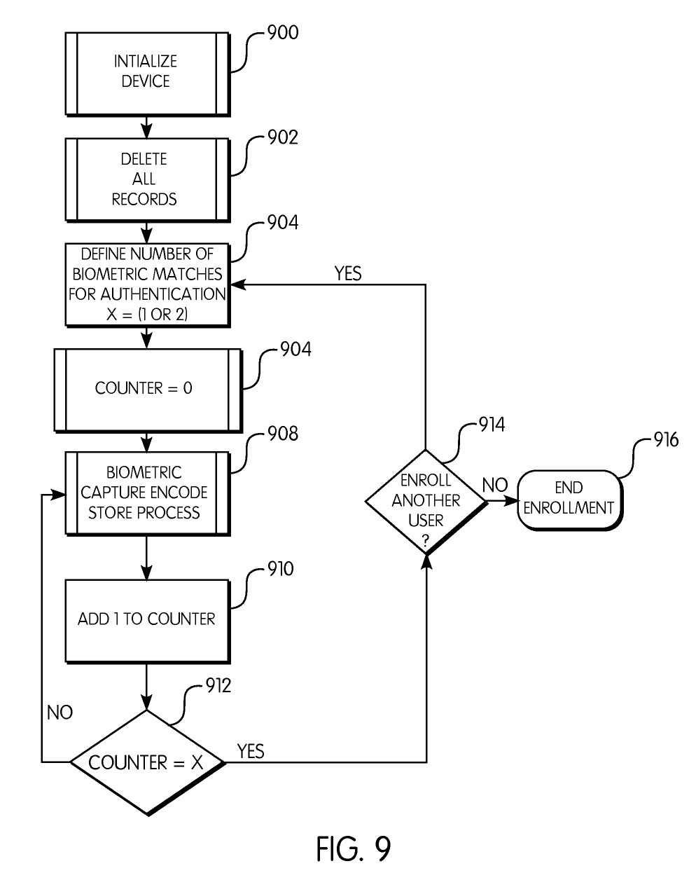

FIG. 9 is a flow chart showing the process by which users are enrolled on device 150. In box 900, the “Initialize Device” process is begun and in box 902, the portion of the memory containing the stored account information and all other user data, such as previously-stored biometric templates, is cleared, to prevent an unauthorized person in physical possession of the unit from adding an authorized user to already existing accounts stored in device 150. In box 904, it is determined how many scans are required for authentication, preferably by asking the user. In the preferred embodiment, it is possible that the user may require multiple scans to authenticate his identity. For example, the user may want to scan multiple fingerprints from different fingers in a specific order to complete the authentication process. Once the appropriate number of scans is determined, a counter is reset in box 906. The biometric capture procedure, which includes the capture, encoding and storage of the biometric template(s), is performed in box 908. Preferably, this functionality will be available as part of an off the shelf component which includes the biometric scanner. In box 910, the counter is incremented and in box 912, it is determined if the required number of biometric samples has been collected. If additional templates are required, box 912 sends control back to box 908, where another template is captured, encoded and stored. If, in box 912 it is determined that the required number of templates has been collected, control is passed to box 914, where it is determined if additional users should be enrolled. If so, control is sent to box 904 to start the enrollment of an additional user. If no additional users are required, the enrollment process is complete in box 916.

In additional embodiments of the device, it may be possible to provide for different types of biometric scans, such as voice recognition, or allowing the use of a PIN in lieu of a biometric scan. This embodiment would require, however, additional controls on the device for inputting the PIN Number. This embodiment is, however, contemplated to be within the scope of the invention.

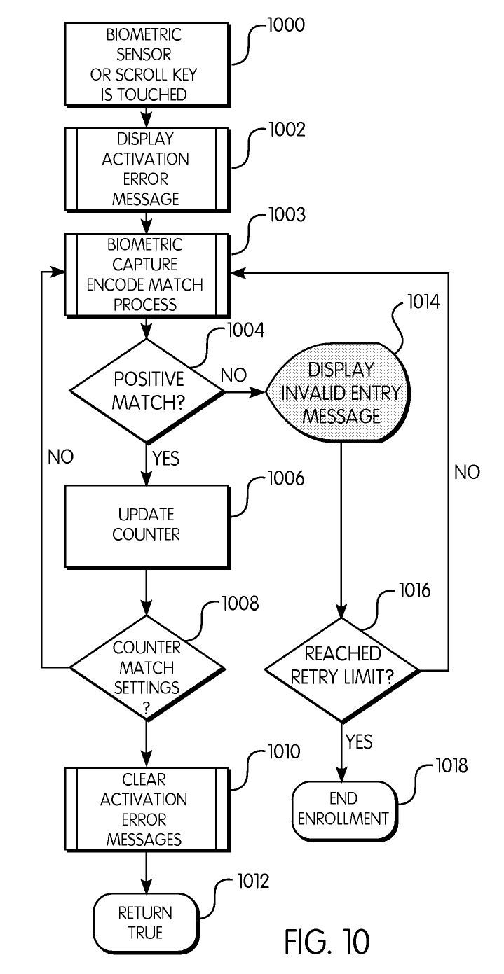

FIG. 10 shows the process to activate the device for use at a POS terminal. The device activation process is a process by which a user is authenticated, thereby unlocking the various accounts associated with that user. The process begins in box 1000 when biometric sensor 151 or either of scroll keys 153 or 154 are touched. In other embodiments of the device, any user input component may start the authentication process. If either of scroll keys 153 or 154 are touched, thereby scrolling the account information, the account currently being displayed on display 152 is the one which will be activated. If biometric sensor 151 is touched, then the currently displayed, or last displayed account will be activated. In box 1002, a message is displayed to prompt the user to complete the authentication process. In the case where a fingerprint scanner is being used, the user places the appropriate finger (or sequence of fingers) on the scanner. The biometric information is collected in box 1003 and encoded in preparation for matching with stored templates of valid biometric scans. In box 1004, the captured biometric is analyzed by comparing it to the stored biometric template which was gathered during the user enrollment process shown in FIG. 9.

If a positive match is made, control passes to box 1006 where a counter is updated to indicate how many positive matches have been made. In box 1008, it is determined if additional biometrics must be collected, and, if so, control is passed back to box 1003. If the correct number of biometrics have been collected and positively matched, control passes to box 1010 where messages are cleared and then to box 1012, where a “TRUE” indication is returned to biometric sensor control 410 on main system board 401.

If any scan fails to match in box 1003, control is sent to box 1014 where an error message is displayed on display 152. In box 1016, it is determined if the number of failed attempts has reached a pre-defined limit, and, if so, control is passed to box 1018, where a FALSE value is returned to biometric sensor control 410, indicating that the device should not be activated. If the retry limit has not been reached, box 1016 returns control to box 1003 where an additional biometric capture is performed.

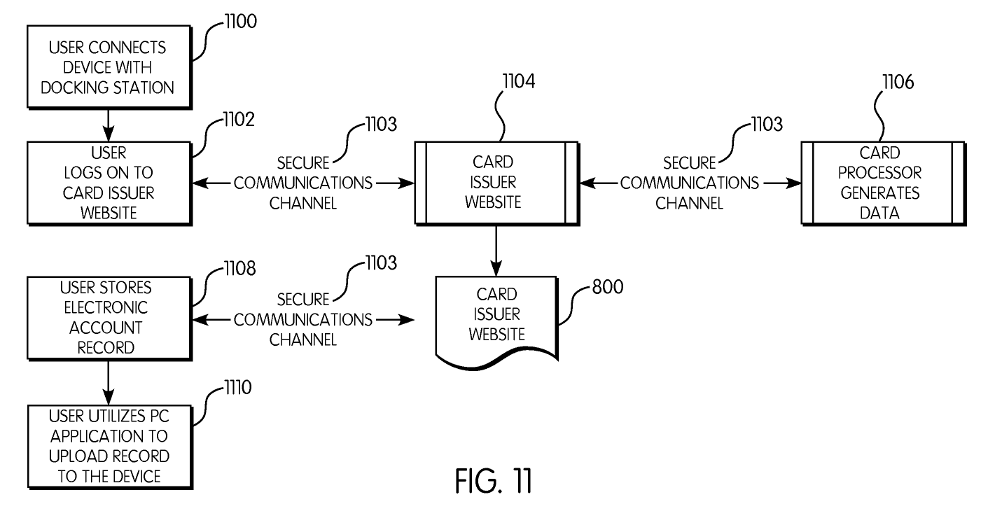

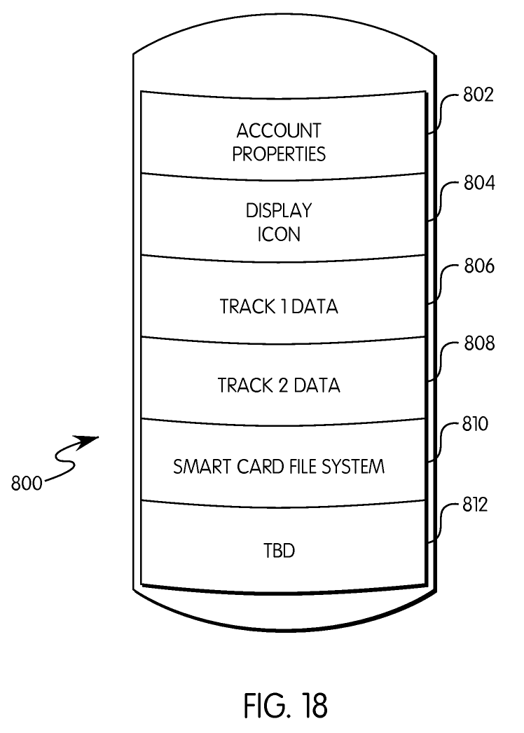

FIG. 11 shows the provisioning process in which account data 800 in electronic form necessary to complete transactions, is downloaded from the account issuer to device 150. This information is shown in FIG. 18, and includes account properties 802, account issuer logos or other graphics 804, track 1 and track 2 data 806 and 808 respectively (required for the programming of programmable magnetic stripe 161), a smartcard file system 810, which may be executable code, and any other data 812 which may or may not be required for completion of the transaction, such as advertising content and/or coupons. Smartcard file system 810 may include executable code to support anti-theft measures, such as the calculation of a rotating account number or a dynamically generated password or verification code.

The account issuer is typically a bank or other credit card issuer, and will provide a structured data file 800, containing the information just discussed, with respect to a particular account. Preferably, structured data file 800 will be available for download from the issuer's web site 1104 via secured channel 1103, or will be available for electronic transfer via any other means well known in the art.

FIG. 11 shows the process by which structured data file 800 is provided to the user. In box 1100, the user inserts device 150 into base unit 700, which is preferably connected to a typical personal computer via any know communications channel, as previously discussed. It is contemplated that, in future embodiments of device 150, it may be possible to establish a wireless connection directly from device 150 to the personal computer, thereby eliminating the need for base unit 700 for communication purposes.

In box 1102, the user logs onto account issuer's web site 1104 using any authentication procedure required thereby, and establishes a secure communication channel 1103 with the account issuer. Preferably, the secure communication channel would be an HTTPS connection, which uses the HTTP protocol over an encrypted SSL or TLS transport protocol to insure secured communications with a web server. However, any encrypted secure communications channel may be utilized. At the user's request, the account issuer generates structured data file 800 in box 1106, specific to the user's account with the account issuer. Structured data file 800 is downloaded over the secured communication channel 1103 to PC 704, where it is stored in box 1108, preferably in some form of permanent storage on PC 704. In box 1110, the user uses PC application 1400 to facilitate the transfer of structured data file 800 to device 150. Preferably, structured data file 800 is encrypted such that it can be read only by device 150 or PC application 1400.

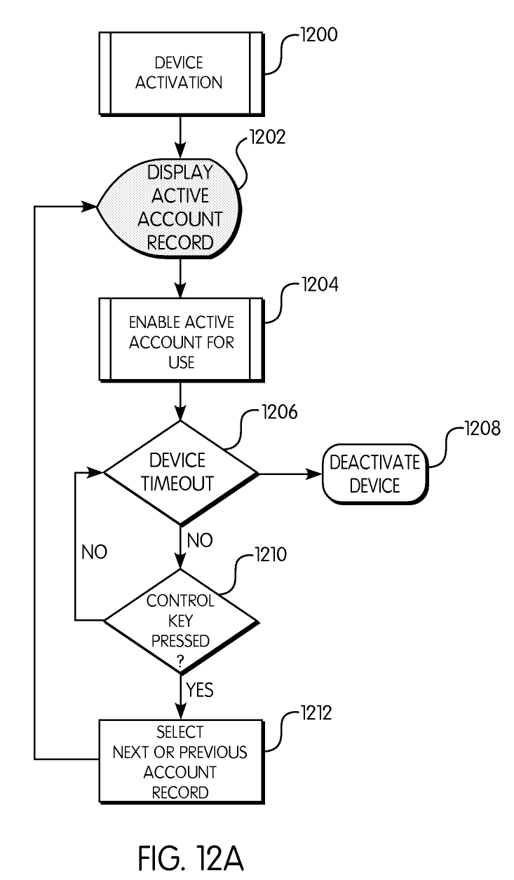

FIG. 12a shows the upper level flow of control for the preferred embodiment of device 150 after the user has been authenticated. In box 1200, the device activation process of FIG. 10 is performed. If successful (i.e., the process shown in FIG. 10 returns a “TRUE” result), control proceeds to box 1202, where the currently active account is displayed. The currently active account may be the first account is a list of accounts, or may be the last activated account. Note that if the activation process of FIG. 10 had returned a “FALSE” result, the device would remain locked and awaiting a request to perform another device activation. The number of unsuccessful device activation requests that may be performed may be limited, requiring that device 150 be connected to PC application 1400 before another attempt at authentication is made.

In box 1004, the currently active account is enabled for use. This means that the account information is programmed into programmable magnetic stripe 161 and/or loaded into the memory which contains the information to be transmitted via RF antenna 173, in the case of a wireless transaction. In addition, any auxiliary information necessary to complete the transaction may be shown on display 151, such as dynamically generated passwords, security codes or CCV codes.

In box 1206, it is determined if the currently active account has been timed-out, and, if so, the device becomes deactivated in box 1208 and the authentication process of FIG. 10 will have to be repeated to reactivate the accounts. If the device is not timed-out, control proceeds to box 1210 where it is determined if one of keys 153 or 154 has been pressed, indicating that the user wishes to scroll to the next or previous account in the list, and to make that account active. The scrolling occurs in box 1212, after which control is passed back to box 1202 to display the new account information. If no key has been pressed in box 1210, the currently active account information is used, and device 150 awaits a time-out in box 1208. Alternatively, it can be determined if the account information has been transmitted, either wirelessly or via a physical swipe wherein programmable magnetic stripe 161 is read, and, if so, the device can be turned off prior to reaching the end of the time-out period.

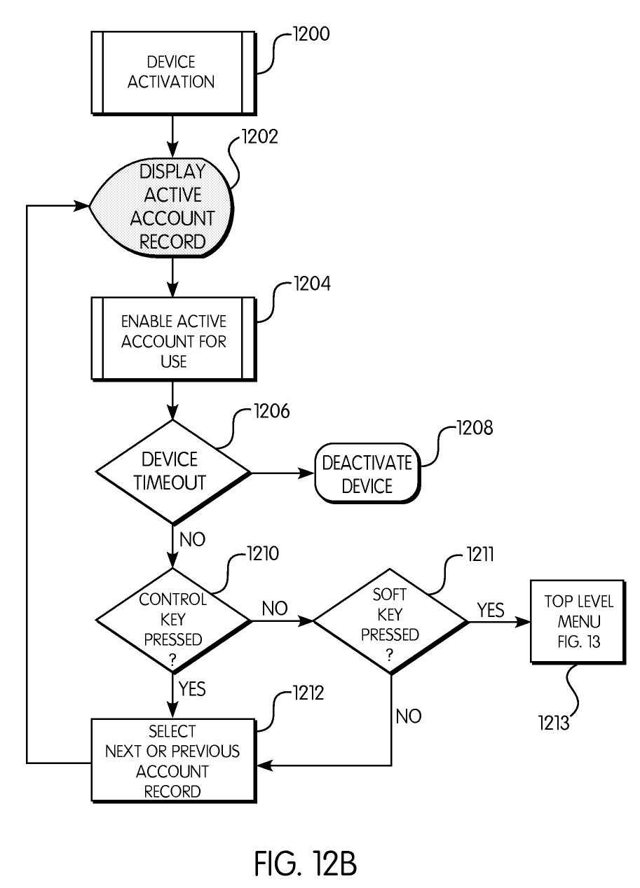

In an alternate embodiment of the process, shown in FIG. 12b, if a key press is detected in box 1210, it is determined in box 1211 if the pressed key is a soft key. If so, control proceeds to box 1213, where the top level of the onboard application menu 1300, shown in FIG. 13 is displayed. Keys 153 and 154 can also be used to navigate this menu. Onboard application menu 1300 provides access to various auxiliary functions of the device. Note that a modification of device 150 may be required to add the soft key to utilize the alternate embodiment of flow control shown in FIG. 12b. Alternatively, the primary embodiment of device 150 may be used if another method of detecting the soft key press, such as detecting the simultaneous pressing of buttons 153 and 154, is utilized.

FIG. 13 shows the top level of the onboard application menu 1300. The top level of application menu 1300 allows users to select from several functions. In box 1302 the user is able to activate the NFC circuitry to download content into device 150 or from device 150 to PC 704 or other near field communications devices. For example, the NFC content download 1302 can be used to move data regarding new accounts from PC 704 to device 150. In addition, data regarding account usage can be downloaded from device 150 to PC application 1400, such as the number of times the account has been used, the amount charged to various accounts, etc. The NFC feature of the device may also be used to communicate with properly-equipped POS terminals or kiosks for other purposes, such as downloading coupons from advertising kiosks, uploading coupons to POS terminals, downloading electronic receipts from POS terminals, downloading product (such as electronic tickets) and content, etc.

In box 1304, camera 106 may be used to capture images, including images of barcodes from coupons or other advertising materials, such as posters. To capture the barcode the user takes a picture of the barcode from wherever it is displayed. The barcode is then interpreted in box 1305 by software which acts similar to optical character recognition software to interpret the contents of the barcode into plain-text. The details of the coupon are then able to be displayed on LCD display 151. In box 1306 the coupon data is stored in on board memory 402 and can be uploaded to application 1400 when the device is connected to the personal computer.

The user may choose to review stored coupons, product or content in box 1310 to determine if they may be used or deleted. Similarly, in box 1312, the user is able to review stored receipts which have been downloaded via the NFC circuitry to memory 402 of device 150. These receipts may eventually be downloaded to PC application 1400 for permanent storage and/or review and printing on the personal computer. Box 1014 is reserved for future expansion of device 150. Future expansion may occur via software updates, which will be applied by via PC application 1400.

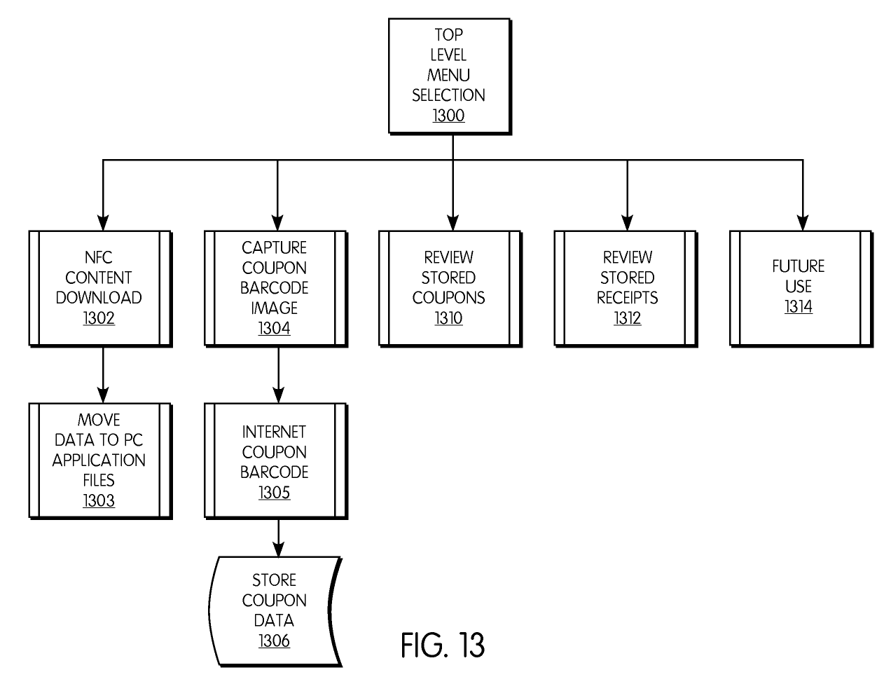

A functional diagram of PC application 1400 is shown in FIG. 14. PC application 1400 preferably runs on PC 704 to which device 150 is connected via base unit 700. Preferably, the computer on which PC application 1400 executes will have a connection to the internet for the downloading of account information from account issuers and the downloading of other content. Thus, PC application 1400 can be of any conventional design for an application of this type as long as all or a subset of the functions as laid out in FIG. 14 are provided.

PC application 1400 allows account records to be maintained in box 1404. This includes defining new account records in 1405, modifying existing account records in box 1406 and deleting existing account records in box 1407. Defining new account records includes the downloading of account information from account issuers in the form of structured data files 800, as previously discussed with respect to FIG. 11. The account information downloaded from the account issuer to PC application 1400 may include advertising material or graphics which are to be displayed on display 151 when the account is activated.

In box 1408, PC application 1400 can synchronize the account data stored thereon and any other content with device 150. PC application 1400 and the permanent storage devices on PC 704 act as a backup for the information stored on device 150 and may retain historical records retrieved from device 150 as well as synchronizing all account record data between device 150 and PC application 1400.

An additional level of protection for account data may be utilized during the synchronization process by personalizing the account data to one specific device 150. In this process, all new account records moved to device 150 will preferably undergo an encryption process unique to device 150. The encryption process will be conducted by software on device 150 and the newly encrypted account data will be moved back to PC 704 for storage, thereby overwriting the un-encrypted version of the account data This will ensure that the account data created will only function on a single device 150 and no other similar device. To accomplish this, each of device 150 will be programmed with a unique serial number or encryption key that is used to encrypt the data for that specific device 150.

PC application 1400 is also capable of acting as a payment agent for purchases made online, with base unit 700 acting as the POS and able to use NFC or wireless smartcard transmission of account data to complete the transaction from device 150. Alternatively, the account information may be transmitted through the smartcard contacts 155 on device 150. Further, if base unit 700 is not present, then payment may be made directly through the personal computer from device 150 using a wireless connection capability.

To make an internet payment, device 150 is activated and the appropriate account is selected. When device 150 is inserted into base unit 700, the account information from device 150 is read via smartcard contacts 155 and the relevant fields on the webpage are populated to render payment for the online purchase.

In a similar vein, device 150 may also be used as an authentication device for logging onto web sites frequented by the user, for which username/password combinations are required for access. When a user logs onto the web site, device 150 will detect the web site and will automatically provide the appropriate username/password combination to allow access to the web site. Other uses contemplated by the inventors include use as a student ID, as an electronic driver's license, as a passport, and for access control to restricted areas of buildings. Generally, anywhere that requires the association of a number or account with a specific person could be aided through the use of device 150 to provide a more secure, means of verification that is less prone to theft and fraud.

PC application 1400 also aids in the management of receipt records by selecting menu item 1412. Receipt records can be downloaded from the device during synchronization process 1409 and records of the receipts are kept for local storage by PC application 1402 on the permanent storage of PC 704. In box 1413, receipts can be exported as image documents in any well know image formats, such as, for example, JPEG, TIFF, PDF or as a text file. Additionally, records of multiple receipts may be exported in a format suitable for reading by a spreadsheet program such as EXCEL. In box 1414 records may be purged from the local storage when they are no longer needed.

Menu item 1416 enables the coupon management feature of PC application 1400. In box 1418, coupons that the user no longer wants to retain can be purged or, alternatively, coupons which have reached their expiration dates may be purged automatically. In addition, it is possible to download coupons from the internet through PC application 1400 and then send these coupons to device 150 during synchronization process 1409.

Menu item 1420 enables various configuration options for PC application 1400, such as the method used by base unit 700 to communicate with the personal computer, the format of the user interface for application 1002 and a variety of other items which may affect the operation of device 150.

In operation, as shown in FIG. 15, device 150 can be used for transactions utilized with POS terminals utilizing a magnetic stripe or RF transmission capability. After the user successfully activates the device, the account record data is used to encode the magnetic stripe emulator on the device. The magnetic stripe emulator can then be swiped through a magnetic stripe reader commonly found at POS terminals. This provides the necessary information to complete the transaction in a manner that works with existing equipment. Existing contactless POS terminals interfaces would also support the device as the means to communicate the required transactional data by utilizing the RF capability.

FIG. 16 shows a transaction between device 150 and an NFC enabled POS device. Here, an interactive session is supported in which the NFC circuitry on device 150 is able to establish a two-way communication with the NFC-enabled POS terminal to exchange key information regarding the transaction, such as the selected account information, any applicable coupons or special offers, etc. In addition, information is able to be downloaded to device 150 from the POS terminal, such as electronic receipt data, information regarding loyalty points, key points for future purchases, advertising content, product (such as electronic tickets) and messages directed to the users. This capability is not present in the transaction shown in FIG. 15 because there is no channel for data to flow from the POS terminal device back to device 150 via magnetic stripe or smartcard interface. In embodiments of device 150 having the NFC circuitry, the NFC circuitry may be used to emulate a smartcard RF transaction.

While it is contemplated that the device be compliant with ISO standards 7810, 7811, 7812 and 7813 for magnetic stripe cards, it is also contemplated that alternative embodiments may not have the magnetic stripe portion and may only communicate with other devices which utilize smartcard technology or which are NFC-enabled.

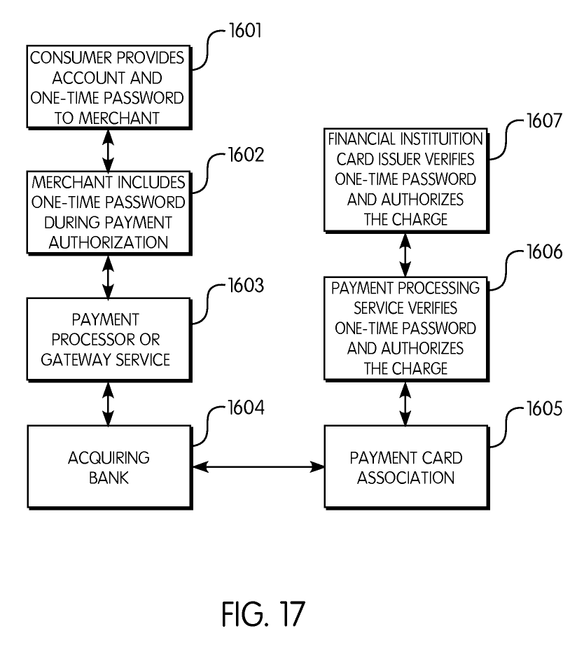

FIG. 17 provides a solution whereby fraud can be eliminated from the credit card process by requiring a dynamically generated one-time password to be included with transaction. This feature is not available with traditional credit cards as there is no computational component with which to calculate a dynamic password.

It is contemplated that different account issuers will have different solutions and algorithms for the generation of the dynamically generated password. Therefore, an encrypting algorithm for generating the dynamic password may be downloaded as part of an electronic account record 800 as shown in FIG. 18, as part of the smartcard file system 810.

The dynamic password generated by device 150 may be transmitted electronically with the rest of the account information to a POS device, and ultimately to the financial institution for authorization of the charge, or may be displayed on display 152 such that a user of the device could read the password and provide it verbally to a merchant or type it into a keypad at the POS device. Alternatively, a non-dynamic alphanumeric security code, such as a CCV code, which does not require calculation, may also be displayed for use by the user in the same manner.

In operation, the password is generated when the user activates the account or when queried by the POS device, and displayed to the user on display 152 or, alternatively is provided as part of the electronic transfer of the account number either via programmable magnetic stripe 161 or via a wireless RF transaction via antenna 173.

This process is shown in FIG. 17. In box 1701, the user provides the account number and dynamic password to the merchant during the normal course of conducting a transaction at a POS terminal. In box 1702, the merchant includes the dynamic password in its transmission to payment processor 1703 as part of the normal payment authorization transmission. The information is then sent to an acquiring bank in box 1704. Alternatively, the merchant may communicate directly with acquiring bank 1704, in set-ups where there is no payment processing service provider. The acquiring bank then transmits the account number and dynamic password to payment card association 1705. Payment card association 1705 transmits the information to the payment processing service in 1706 which verifies the one-time password as being authentic for that particular account, and authorizes the charge. In box 1707 the financial card issuer also verifies the dynamic password and authorizes the charge. The authorization is then returned to acquiring bank 1704 The payment processor or gateway server 1703 then transmits the authorization to the merchant and the transaction is completed. Note that one or more of the entities in FIG. 17 may be the same entity.

The user of a password which is dynamically generated based upon a unique identification of device 150 eliminates the type of fraud wherein credit numbers are stolen and then used to purchase goods either in person, by embossing the number on another card or over the internet by simply conducting internet transactions wherein the card number is provided. This method also eliminates having the security code or CCV code printed on the signature panel of the card. As such, the theft of the dynamically generated security code is virtually impossible.

Note that the embodiments shown are provided as exemplars only and the invention is not meant to be limited thereby. For example, actual physical configuration of device 150 may change depending on the needs of the applications which are run thereon. For example, certain applications may require larger or smaller displays or certain embodiments in the invention may include, for example, speakers and/or microphones. Likewise, the layout of the keys 153 and 154, and, in addition, the number and placement of additional keys, may be of any configuration that is convenient for the user. Biometric sensor 151 may be located in any convenient place on or within the housing of device 150. Likewise, the system architecture shown in FIG. 7 is only one possible embodiment. The system architecture may be configured in any manner which provides the functionality necessary for the emulation of magnetic stripes, smartcards and/or NFC in the manner described herein.

We claim:

1. A device for performing point of sale transactions comprising:
a. a housing, said housing being the approximate size of a credit card;
b. a biometric sensor;
c. memory, for storing information regarding one or more accounts;
d. a user interface, for selecting one of said one or more accounts stored in said memory;
e. a display component, for displaying information about said selected account; and
f. an RF interface, including an RF antenna, for providing said selected account information in electronic form to a point of sale device.

2. The device of claim 1 wherein said biometric sensor is used to verify the identity of a user of said device by comparing one or more biometrics collected from said user with one or more previously-stored biometrics collected from said user.

3. The device of claim 2 wherein said user interface comprises one or more buttons.

4. The device of claim 3 wherein said one or more accounts are arranged in a list and further wherein said one or more buttons can be used to navigate said list by scrolling forward or backward through said list to select one of said one or more accounts.

5. The device of claim 2 wherein information regarding said selected account is displayed on said display component.

6. The device of claim 5 wherein said display component is an LCD display.

7. The device of claim 5 wherein said information regarding said selected account includes any information necessary to complete a transaction at a point of sale device which is not transmitted electronically by said device.

8. The device of claim 2 wherein said RF interface is disabled until the identity of said user is verified.

9. The device of claim 5 wherein said RF interface is a smartcard interface.

10. The device of claim 8 wherein said RF interface can transmit information regarding said selected account when queried by a point of sale device.

11. The device of claim 10 wherein said RF interface is disabled after one of a transmission of said selected account information or a predetermined time period.

12. The device of claim 2 further comprising a programmable magnetic stripe capable of being programmed with said selected account information and thereafter erased.

13. The device of claim 12 wherein said programmable magnetic stripe is programmed with said selected account information only after the identity of an authorized user of said device is verified via said biometric sensor.

14. The device of claim 10 wherein said programmable magnetic stripe is erased or rendered unreadable after it has been read by a swiping it at a point of sale device or after a predetermined time period.

15. The device of claim 2 wherein said biometric is a fingerprint and further wherein said biometric sensor is a fingerprint scanner.

16. The device of claim 7 wherein said information necessary to complete a transaction at a point of sale device which is not transmitted electronically by said device is a dynamically generated password which is calculated by said device.

17. The device of claim 16 wherein said dynamically generated password is unique for each transaction.

18. The device of claim 16 wherein said dynamic password is calculated by said device based on an algorithm stored in said memory of said device.

19. The device of claim 17 wherein said algorithm is supplied by the issuer of said selected account and downloaded to said device.

20. The device of claim 1 wherein said account information which is transmitted in electronic form to a point of sale device includes a dynamically generated password which is calculated by said device.

21. The device of claim 20 wherein said dynamic password is calculated by said device based on an algorithm stored in said memory of said device.

22. The device of claim 21 wherein said algorithm is supplied by the issuer of said selected account and downloaded to said device.

23. The device of claim 7 wherein said information necessary to complete a transaction at a point of sale device which is not transmitted electronically by said device is an alphanumeric password.

24. The device of claim 1 further comprising a plurality of electrical contacts on the exterior of said housing of said device.

25. The device of claim 24 wherein said plurality of electrical contacts conforms to the smartcard specification.

26. The device of claim 24 further comprising a rechargeable battery.

27. The device of claim 26 wherein said rechargeable is able to be recharged through said plurality of electrical contacts.

28. The device of claim 26 wherein said rechargeable battery is able to be recharged using inductive coupling when said RF antenna is exposed to RF energy.

29. The device of claim 24 wherein said device can exchange data with a computer through said plurality of electrical contacts.

30. The device of claim 29 wherein account information can be downloaded to said device through said plurality of electrical contacts.

31. The device of claim 29 wherein executable code can be downloaded to said device through said plurality of electrical contacts.

32. The device of claim 14 wherein said programmable magnetic strips is capable of having data programmed on at least track 1 and track 2 of said magnetic stripe.

33. The device of claim 14 wherein said programmable magnetic stripe may be written by a point of sale device and further wherein said information written onto said programmable magnetic stripe may be read by said device and stored in said memory of said device.

34. The device of claim 26 further comprising a photovoltaic cell which can be used to recharge said battery when exposed to ambient light.

35. The device of claim 1 further comprising a near-field communications (NFC) interface.

36. The device of claim 35 wherein said NFC interface can be used to upload selected account information to a point of sale device.

37. The device of claim 35 wherein said NFC interface can be used to upload coupon information to a point of sale device.

38. The device of claim 35 wherein said NFC interface can be used to download content to said device from a point of sale device or other NFC-enabled terminal.

39. The device of claim 38 wherein said content is selected from a group consisting of advertising, electronic receipts, electronic coupons and electronic tickets.

40. The device of claim 1 wherein said device can be used as a means of identification.

41. The device of claim 40 wherein said device can be used as a means of identification selected from group consisting of student IDs, employee IDs, driver's licenses and passports.

42. The device of claim 1 wherein said device can be used for access control.

43. A device for performing point of sale transactions comprising:
a. a housing, said housing being the approximate size of a credit card;
b. a fingerprint scanner;
c. memory, for storing information regarding one or more accounts;
d. one or more buttons for selecting one of said one or more accounts;
e. a display, for displaying information about one of said accounts, said displayed account being the currently selected account;
f. an RF interface for providing said currently selected account information in electronic form to a point of sale device; and
g. a programmable magnetic stripe capable of being programmed with said currently selected account information and thereafter erased.

44. The device of claim 43 wherein said device can calculate a dynamically generated password for each account or for each transaction for each account.

45. The device of claim 44 wherein said dynamically generated password can be transmitted electronically through said RF interface or through said programmable magnetic stripe.

46. The device of claim 44 wherein aid dynamically generated password is displayed on said display.

47. The device of claim 43 wherein information necessary to complete a transaction at a point of sale terminal which is not transmitted electronically to said point of sale terminal electronically is displayed on said display.

48. The device of claim 47 wherein said information necessary to complete a transaction at a point of sale terminal which is not transmitted electronically is a CCV or security code.

49. A system for performing point-of-sale transactions comprising:
a. a computer running an application; and
b. a handheld component comprising:
memory, for storing information regarding one or more accounts;
a user interface, for selecting one of said one or more accounts stored in said memory;
a biometric sensor, for verifying the identity of a user of said device;
an RF interface for transmitting said selected account information in electronic form to a point of sale terminal; and
a data port for communicating with said application; and

50. The system of claim 49 wherein said application can download account information from account issuers over the internet and store said account information on said computer.

51. The system of claim 50 wherein said account information can be downloaded to said handheld component and stored in said memory therein.

52. The system of claim 50 wherein said account information is downloaded to said handheld component, encrypted on said handheld component, and sent back to said application for storage on said computer.

53. The system of claim 49 wherein said application can download content to said handheld component.

54. The system of claim 53 wherein said content includes advertising and coupons.

55. The system of claim 48 wherein said RF interface is a near field communications (NFC) interface.

56. The system of claim 55 wherein said NFC interface can emulate a smartcard to enable contactless transactions with smartcard enabled point-of-sale terminals.

57. The system of claim 55 wherein said handheld device can communicate with point-of-sale devices and other NFC-enabled devices which are also NFC-enabled.

58. The system of claim 57 wherein said handheld component can receive content downloads from NFC-enabled devices.

59. The system of claim 58 wherein said content is selected from a group consisting of advertising, electronic receipts, electronic coupons and electronic tickets.

60. The system of claim 59 wherein said downloaded content can be copied to said PC by said application for printing and permanent storage.

61. The system of claim 49 wherein said handheld component can be electronically coupled with said computer, allowing synchronization between said application and said handheld component.

62. The system of claim 49 further comprising a base unit, connected to said computer via a cable or a wireless connection, said base unit having a connector capable of mating with said data port on said handheld component.

63. The system of claim 62 wherein said data port consists of a plurality of electronic contacts.

64. The system of claim 63 wherein said handheld component further comprises a rechargeable battery which can be recharged through said data port or inductively through exposure to RF waves.

65. The system of claim 49 wherein said handheld component further comprises a programmable magnetic stripe capable of being programmed with said selected account information and thereafter erased.

66. The device of claim 65 wherein said programmable magnetic stripe is programmed with said selected account information only after the identity of an authorized user of said device is verified via said biometric sensor.

67. The device of claim 65 wherein said programmable magnetic stripe is erased or rendered unreadable after it has been read by a swiping it at a point of sale device or after a predetermined time period.

68. The device of claim 49 wherein said RF interface is disabled until the identity of said user is verified using said biometric sensor.

69. The device of claim 49 wherein said RF interface is a smartcard interface.

70. The device of claim 68 wherein said RF interface can transmit information regarding said selected account when queried by a point of sale device.

71. The device of claim 70 wherein said RF interface is disabled after one of a transmission of said selected account information or a predetermined time period

72. The device of claim 49 wherein information regarding said selected account is displayed on said display.

73. The device of claim 72 wherein said information regarding said selected account includes any information necessary to complete a transaction at a point of sale device which is not transmitted electronically by said device.

74. The device of claim 73 wherein said information necessary to complete a transaction at a point of sale device which is not transmitted electronically by said device is a dynamically generated password which is calculated by said device.

75. The device of claim 74 wherein said dynamically generated password is unique for each transaction.

76. The device of claim 74 wherein said dynamic password is calculated by said device based on an algorithm stored in said memory of said device.

77. The device of claim 76 wherein said algorithm is supplied by the issuer of said selected account and downloaded to said device.

78. The device of claim 49 wherein said account information which is transmitted in electronic form to a point of sale device includes a dynamically generated password which is calculated by said device.

79. The device of claim 78 wherein said dynamic password is calculated by said device based on an algorithm stored in said memory of said device.

80. The device of claim 79 wherein said algorithm is supplied by the issuer of said selected account and downloaded to said device.

81. The device of claim 73 wherein said information necessary to complete a transaction at a point of sale device which is not transmitted electronically by said device is an alphanumeric password.

82. The device of claim 27 wherein said rechargeable battery is able to be recharged by a cellular phone having a set of mating contacts.

83. A device for performing point of sale transactions comprising:
a. a cellular telephone, including a housing;
b. a biometric sensor, disposed on said housing;
c. memory, for storing information regarding one or more accounts;
d. a user interface, for selecting one of said one or more accounts stored in said memory;
e. a display component, for displaying information about said selected account; and
f. an RF interface, including an RF antenna, for providing said selected account information in electronic form to a point of sale device.
